(19) United States
(12) Patent Application Publication
(10) Pub. No.: US 2025/0018516 A1
(43) Pub. Date: Jan. 16, 2025

(54) WORKING MACHINE

(71) Applicant: Makita Corporation, Anjo-shi (JP)

(72) Inventors: Keisuke YOSHIDA, Anjo-shi (JP); Toshiaki Sugiura, Anjo-shi (JP)

(73) Assignee: Makita Corporation, Anjo-shi (JP)

(21) Appl. No.: 18/768,770

(22) Filed: Jul. 10, 2024

(30) Foreign Application Priority Data
Jul. 14, 2023 (JP) 2023-116243

(51) Int. Cl. B23Q 17/24; A01G 3/053; B23Q 11/00; F21V 33/00; G06V 10/14; G06V 10/56; G06V 20/50

(52) U.S. Cl. CPC B23Q 17/2438; F21V 33/0084; G06V 10/14; G06V 10/56; G06V 20/50; A01G 3/053; B23Q 11/0089

(57) ABSTRACT

A working machine may include: a working unit; a prime mover configured to drive the working unit; an image capture unit configured to capture image data of an area near the working unit; and a control unit. The working machine may be configured to operate in a normal mode in which the working machine operates normally and in a safe mode in which the working machine operates more safely than in the normal mode, and the control unit may be configured to operate the working machine in the safe mode when the control unit determines that an object is approaching the working unit based on a number of pixels of which hue when the pixels are represented in an HSV format is within a predetermined range among pixels included in the image data captured by the image capture unit.

### REFERENCE TO RELATED APPLICATIONS

This application claims priority from Japanese Patent Application No. 2023-116243 filed on Jul. 14, 2024. The entire content of the priority application is incorporated herein by reference.

### TECHNICAL FIELD

The art disclosed herein relates to a working machine.

### BACKGROUND ART

Japanese Patent Application Publication No. 2010-23186 describes a working machine including: a working unit, a prime mover configured to drive the working unit; an image capture unit configured to capture image data of an area near the working unit; and a control unit. The working machine is configured to operate in a normal mode in which the working machine operates normally and a safe mode in which the working machine operates more safely than in the normal mode. The control unit is configured to operate the working machine in the safe mode when the control unit determines that an object is approaching the working unit based on a number of pixels of which color value when the pixels are represented in a YUV format is a designated value among pixels included in the image data captured by the image capture unit.

### SUMMARY

When a working machine is used outdoors, image data may be captured in a luminous environment or in a dark environment. If the image data is represented in the YUV format or an RGB format, even if images of objects of the same color are captured, the images may exhibit different color values depending on luminance at the time of the images being captured. Due to this, it may be difficult to detect with high precision that an object such as a user's body is approaching the working unit when the working unit is used outdoors. The present teachings provide an art that allows to detect with high precision that an object is approaching a working unit based on image data captured by an image capture unit even when the working unit is used outdoors.

A working machine disclosed herein may comprise: a working unit; a prime mover configured to drive the working unit; an image capture unit configured to capture image data of an area near the working unit; and a control unit. The working machine may be configured to operate in a normal mode in which the working machine operates normally and in a safe mode in which the working machine operates more safely than in the normal mode. The control unit may be configured to operate the working machine in the safe mode when the control unit determines that an object is approaching the working unit based on a number of pixels of which hue when the pixels are represented in an HSV format is within a predetermined range among pixels included in the image data captured by the image capture unit.

When image data captured by the image capture unit is represented in the HSV format including a hue, a saturation, and a value (brightness), objects of the same color exhibit the same hue even when they are captured in environments of different luminance. Due to this, according to the above configuration, it can be detected with high precision that an object is approaching the working unit based on the image data captured by the image capture unit even when the working machine is used outdoors.

### BRIEF DESCRIPTION OF DRAWINGS

FIG. 1 is a block diagram showing a schematic configuration of a working machine 2 according to an embodiment.

FIG. 2 is a perspective view of a working unit 8 in the working machine 2 according to the embodiment seen from a front right upper side.

FIG. 3 is a vertical cross-sectional view of the working unit 8 in the working machine 2 according to the embodiment in a state where a movable blade 34 is open relative to a fixed blade 32.

FIG. 4 is a perspective view of an internal structure of the working unit 8 in the working machine 2 according to the embodiment seen from the front right upper side.

FIG. 5 is a vertical cross-sectional view of the working unit 8 in the working machine 2 according to the embodiment in a state where the movable blade 34 is closed relative to the fixed blade 32.

FIG. 6 is a perspective view of the working unit 8 in the working machine 2 according to the embodiment seen from a front left upper side.

FIG. 7 is a perspective view of when a branch 82 is being cut by using the working machine 2 according to the embodiment seen from a rear upper side.

FIG. 8 is a flowchart of an approach assessment process performed by a control unit 14 of the working machine 2 according to the embodiment.

FIG. 9 is an example for image data ID captured by a camera 74 when the camera 74 is not blocked in the working machine 2 according to the embodiment.

FIG. 10 is an example for image data ID captured by the camera 74 when the camera 74 is blocked by an obstacle 84 in the working machine 2 according to the embodiment.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved working machines, as well as methods for using and manufacturing the same.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, the control unit may be configured to determine whether the object is approaching the working unit based on the number of pixels of which hue when the pixels are represented in the HSV format is within the predetermined range and of which saturation when the pixels are represented in the HSV format is equal to or higher than a threshold value among the pixels included in the image data captured by the image capture unit.

When image data captured by the image capture unit is represented in the HSV format, a color with a low saturation such as white, black or gray may exhibit a same hue as a hue of a color with high saturation (e.g., purple). Due to this, if an assessment on whether a pixel corresponds to an object or not is attempted based on the hue of that pixel alone, a pixel which captured a color with a low saturation may be erroneously assessed as the pixel corresponding to the object. According to the above configuration, since a determination is made on whether the object is approaching the working unit or not based on the number of pixels of which hue is within the predetermined range and of which saturation is equal to or higher than a threshold value, such erroneous detection caused by a color with a low saturation having been captured can be suppressed.

In one or more embodiments, the control unit may be configured to set the threshold value to a lower value as a brightness of a pixel when the pixel is represented in the HSV format included in the image data captured by the image capture unit is higher.

Generally, when image data is captured in a luminous environment, a saturation of a pixel corresponding to an object tends to be low, whereas when image data is captured in a dark environment, a saturation of a pixel corresponding to the object tends to be high. According to the above configuration, because the threshold value for the saturation is set to a lower value as the brightness of the pixel included in the image data is higher, approaching motion of the object toward the working unit can be detected with higher accuracy.

In one or more embodiments, the predetermined range may be 230 degrees to 360 degrees.

When the working machine is used outdoors, a blue color of sky, a green color of plants, and/or a brown color of tree branches or trunks may be captured in image data captured by the image capture unit. Hues of these colors are within a range of 0 degrees to 230 degrees, and a color of which hue is within a range of 230 degrees to 360 degrees (e.g., purple) is rarely captured in the image data. According to the above configuration, by setting the hue of a color of an object within the range of 230 degrees to 360 degrees, it is possible to detect with high precision that the object is approaching the working unit.

In one or more embodiments, the working machine may further comprise a housing supporting the working unit and the image capture unit and configured to be gripped by a user. The working unit may comprise a fixed blade and a movable blade, the movable blade being configured to pivot around a pivot axis extending in a left-right direction with respect to the fixed blade and configured to be driven by the prime mover.

The above-described working machine works as pruning shears for pruning branches for example. A user may work with one hand grasping the housing and another hand grasping a branch when the user is to cut the branches using the working machine. According to the above configuration, by wearing a glove in a color of which hue falls into the predetermined range (e.g., purple) on the other hand, the working machine can be made to operate in the safe mode when the glove being the object is approaching the working unit. User safety can be ensured.

In one or more embodiments, the image capture unit may be arranged on an upper side of the housing.

In a configuration where the working unit comprises a fixed blade and a movable blade, if the image capture unit is disposed on a right side (or left side) of the housing, an area to the right (or to the left) of the working unit enters a field of view of the image capture unit but an area to the left (or to the right) of the working unit is blocked by the working unit thus does not enter the field of view of the image capture unit, as a result of which it becomes difficult to capture the areas to both left and right sides of the working unit. Likewise, if the image capture unit is disposed on a bottom side of the housing, although the areas to both right and left of the working unit can be captured, the image capture unit would protrude downward from the housing, which often disturbs the work. According to the above configuration, since the image capture unit is disposed on an upper side of the housing, the areas to the right and left of the working unit can be captured. Also, the image capture unit can be suppressed from protruding downward from the housing and thus disturbing the work.

In one or more embodiments, when the movable blade is opened maximally with respect to the fixed blade and a longitudinal direction of the housing is set as a horizontal direction, the image capture unit may be arranged below an upper end of the movable blade.

Even when the image capture unit protrudes upward from the housing because the image capture unit is disposed on the upper side of the housing, as long as the image capture unit is located below the upper end of the movable blade in a state where the movable blade is opened maximally, the image capture unit hardly disturbs the work. According to the above configuration, even when the image capture unit protrudes upward from the housing, the image capture unit can be suppressed from disturbing the work.

In one or more embodiments, the working machine may further comprise an illumination unit supported by the housing and configured to illuminate the area near the working unit.

According to the above configuration, even in a dark environment, because image data can be captured with the illumination unit illuminating the area near the working unit, the image data can be obtained under a same condition as when the image data is captured in a luminous environment. Variation in detection accuracy due to differences in luminance of environments can be suppressed.

In one or more embodiments, the illumination unit may comprise a right illumination unit arranged on a right side of the housing and a left illumination unit arranged on a left side of the housing.

In the configuration where the working unit comprises a fixed blade and a movable blade, if the working unit comprises only the right illumination unit (or only the left illumination unit), the area to the right (or to the left) of the working unit is illuminated while the area to the left (or to the right) of the working unit is not illuminated, thus it becomes difficult to illuminate the both areas to the right and left of the working unit. According to the above configuration, because the working machine comprises both the right illumination unit and the left illumination unit, the areas to the right and left of the working unit can both be suitably illuminated.

In one or more embodiments, the control unit may be configured to: specify a first pixel and a second pixel among the pixels included in the image data, the first pixel arranged at a position corresponding to the fixed blade, and the second pixel arranged at a position corresponding to neither the fixed blade nor the movable blade, and determine whether the image capture unit is blocked by an obstacle based on hues, saturations, and/or brightness of the first pixel and the second pixel when the first and second pixels are represented in the HSV format.

When the image capture unit is not blocked by an obstacle, a same color (i.e., color of the fixed blade) is constantly captured in the first pixel arranged at the position corresponding to the fixed blade, and a color of background is captured in the second pixel arranged at the position that is not corresponding to the fixed blade or the movable blade. In this case, the first pixel and the second pixel exhibit different hues, saturations, and brightnesses. Contrary to this, when the image capture unit is blocked by an obstacle, the same color of the obstacle is captured by both the first pixel arranged at the position corresponding to the fixed blade and the second pixel arranged at the position corresponding to neither the fixed blade nor movable blade. In this case, the first and second pixels exhibit substantially same hues, saturations, and brightnesses. According to the above configuration, whether the image capture unit is blocked by an obstacle or not can be suitably distinguished based on hues, saturations, and/or brightnesses of the first pixel arranged at the position corresponding to the fixed blade and the second pixel arranged at the position corresponding to neither the fixed blade nor the movable blade.

In one or more embodiments, an angle of view in the left-right direction of the image capture unit may be within a range of 60 degrees to 120 degrees.

If an angle of view is too wide in the left-right direction, even when the object is not so close to the working unit with respect to the left-right direction, the object would be captured in the image data. Conversely, if the angle of view is too narrow in the left-right direction, the object would not be captured in the image data until the object has significantly approached the working unit. According to the above configuration, whether the object is approaching the working unit or not with respect to the left-right direction can be suitably detected.

In one or more embodiments, an angle of view in an up-down direction of the image capture unit may be within a range of 45 degrees to 90 degrees.

If the angle of view is too wide in the up-down direction, even when the object is not so close to the working unit with respect to the up-down direction, the object would be captured in the image data. Conversely, if the angle of view is too narrow in the up-down direction, the object would not be captured in the image data until the object has significantly approached the working unit. According to the above configuration, whether the object is approaching the working unit with respect to the up-down direction or not can be suitably detected.

In one or more embodiments, a shutter speed of the image capture unit may be within a range of 0.1 ms to 2 ms.

According to the above configuration, the image data can be captured in a suitable luminance when the working machine is used outdoors.

In one or more embodiments, the safe mode may include a first safe mode in which the working machine operates more safely than in the normal mode and a second safe mode in which the working machine operates more safely than in the first safe mode. The control unit may be configured to operate the working machine in the first safe mode when it is determined that the object is approaching the working unit at a first approach level based on the number of the pixels of which hue when the pixels are represented in the HSV format is within the predetermined range among the pixels included in the image data captured by the image capture unit. The control unit may be configured to operate the working machine in the second safe mode when it is determined that the object is approaching the working unit at a second approach level that is closer than the first approach level based on the number of the pixels of which hue when the pixels are represented in the HSV format is within the predetermined range among the pixels included in the image data captured by the image capture unit.

According to the above configuration, the working machine can be caused to operate in a safer mode in incremental steps according to the approach level of the object to the working unit.

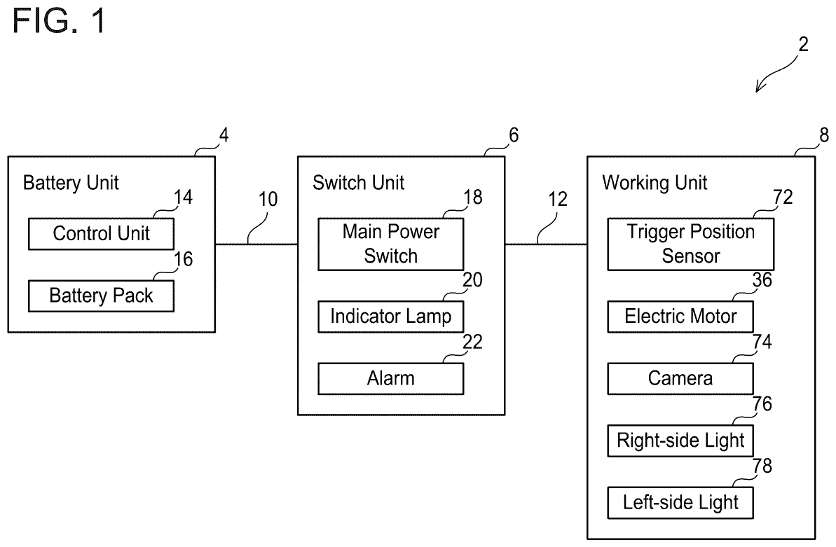

(EMBODIMENTS) As shown in FIG. 1, a working machine 2 comprises a battery unit 4, a switch unit 6, and a working unit 8. The working machine 2 is pruning shears used for stems or branches of weeds, flowers, and/or trees for example. The battery unit 4 is attached to a harness (not shown), the harness comprises a shoulder belt and a chest belt and is worn by a user. The switch unit 6 is attached to the chest belt of the harness. The working unit 8 is used in a manner of being gripped by one hand of the user. The battery unit 4 and the switch unit 6 are electrically connected via a cable 10. The switch unit 6 and the working unit 8 are electrically connected via a connection cord 12.

The battery unit 4 comprises a control unit 14 and a battery pack 16. The control unit 14 comprises CPU, ROM, RAM, etc., and is configured to control operation of the working machine 2. The battery pack 16 is removably attached to the battery unit 4. The battery pack 16 comprises a secondary battery such as a lithium-ion battery. The working machine 2 operates with power supplied from the battery pack 16.

The switch unit 6 comprises a main power switch 18, an indicator lamp 20, and an alarm 22. The main power switch 18 accepts user's operation of switching on/off of the main power of the working machine 2. The indicator lamp 20 displays a state of on/off of the main power of the working machine 2 and presence/absence of abnormality for a user of the working machine 2. The alarm 22 emits a warning sound for the user of the working machine 2.

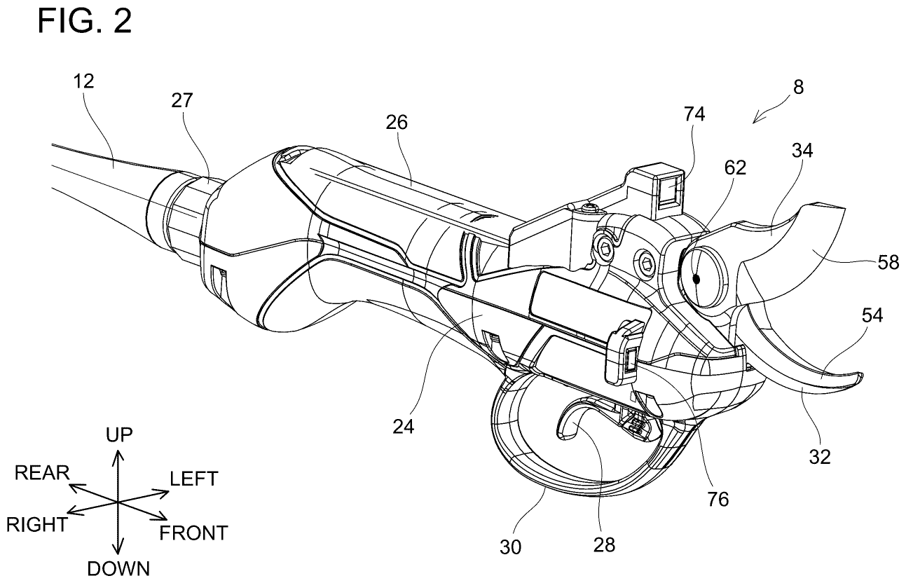

As shown in FIG. 2, the working unit 8 comprises a housing 24. The housing 24 has a longitudinal direction in a front-rear direction. The housing 24 has a grip 26 configured to be gripped by the user with one hand formed thereon. A connector 27 configured to detachably receive the connection cord 12 is disposed at a rear end of the housing 24. A trigger 28 configured to be operated by the user and a guard 30 configured to guard finger(s) of the user operating the trigger 28 are disposed on a front side relative to the grip 26 of the housing 24. The trigger 28 and the guard 30 are disposed on a lower side of the housing 24. The fixed blade 32 and the movable blade 34 configured to pivot relatively to the fixed blade 32 are disposed at a front end of the housing 24. The movable blade 34 is arranged adjacent to and to the right of the fixed blade 32.

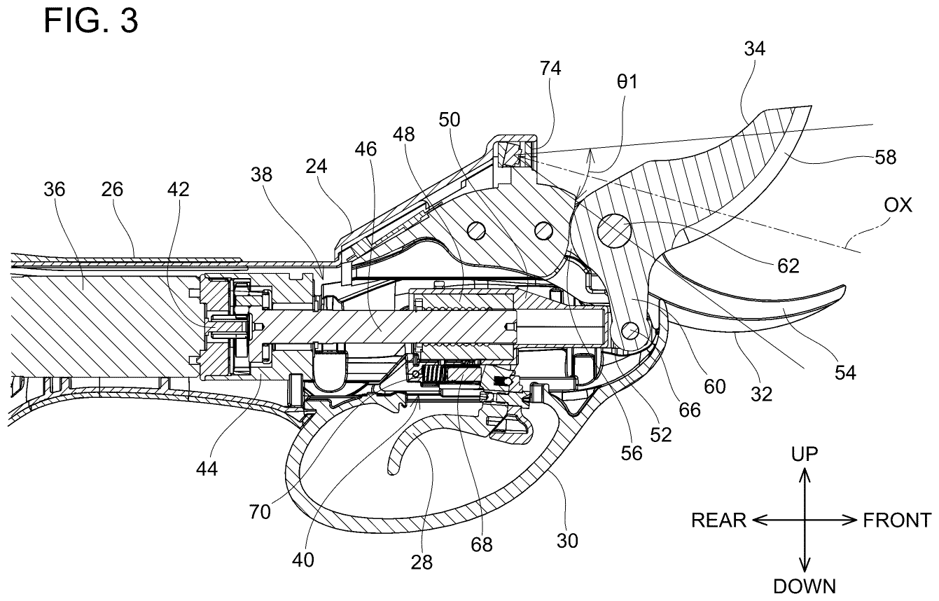

As shown in FIG. 3, an electric motor 36, a power transmitting part 38, and a trigger position detector part 40 are accommodated in the housing 24. The electric motor 36 is for example a DC brushless motor, such as a coreless motor. The electric motor 36 is disposed inside the grip 26. An output shaft 42 of the electric motor 36 extends frontward.

The power transmitting part 38 comprises a reduction mechanism 44, a screw shaft 46, a nut 48, a nut casing 50, and a link arm 52. The reduction mechanism 44 is for example a planetary gear mechanism and configured to reduce rotation of the output shaft 42 and transmit the reduced rotation to the screw shaft 46. The screw shaft 46 and the nut 48 constitute a so-called ball-screw mechanism. The nut 48 is fixed to the nut casing 50. When the screw shaft 46 rotates forward, the nut 48 and the nut casing 50 move rearward relative to the housing 24. When the screw shaft 46 rotates in reverse, the nut 48 and the nut casing 50 move frontward relative to the housing 24.

The fixed blade 32 comprises a lower blade part 54 and a support part 56. The support part 56 is fixed to the housing 24. The movable blade 34 comprises an upper blade part 58 and a lever part 60. The movable blade 34 is coupled to the fixed blade 32 via a bolt 62 extending in a left-right direction such that the movable blade 34 is pivotable.

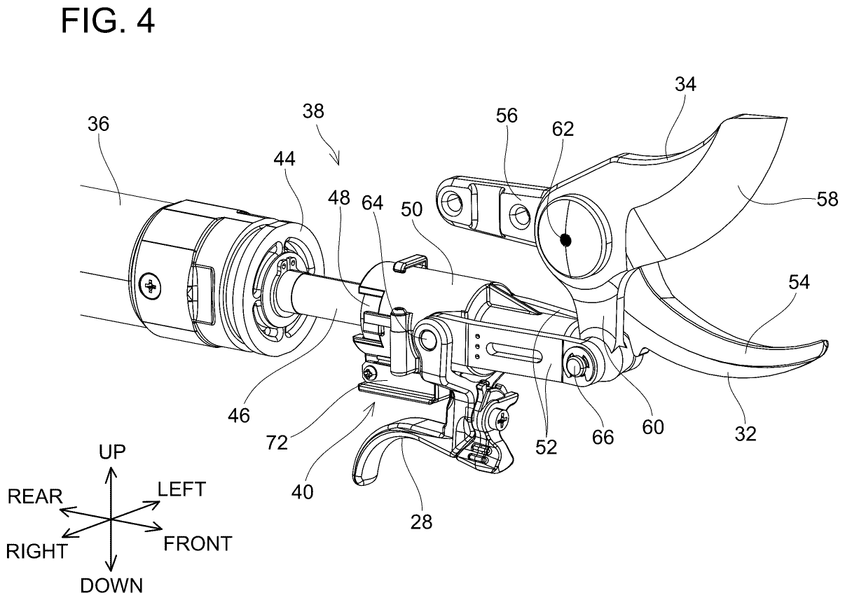

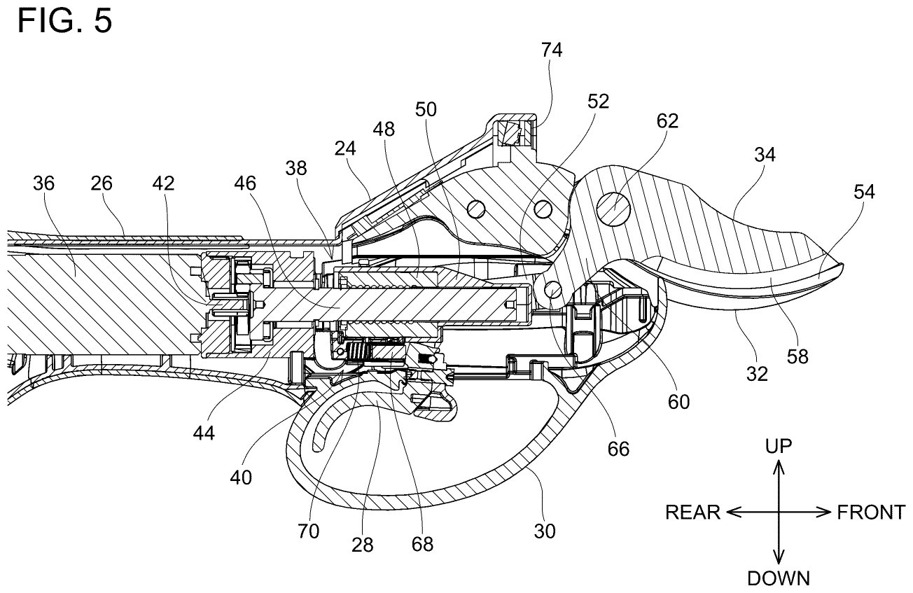

As shown in FIG. 4, the link arm 52 extends in the front-rear direction. A rear end of the link arm 52 is pivotably coupled to the nut 48 via a pin 64 extending in the left-right direction. A front end of the link arm 52 is pivotably coupled to the lever part 60 via a pin 66 extending in the left-right direction. As shown in FIG. 5, when the nut 48 and the nut casing 50 move rearward, a lower end of the lever part 60 moves rearward, by which the movable blade 34 pivots about the bolt 62 as a pivot axis, clockwise in FIG. 5. Due to this, the movable blade 34 is closed relative to the fixed blade 32, and thus cutting work by the upper blade part 58 and the lower blade part 54 is performed. Conversely, when the nut 48 and the nut casing 50 move frontward as shown in FIG. 3, the lower end of the lever part 60 move frontward, by which the movable blade 34 pivots about the bolt 62 as the pivot axis counterclockwise in FIG. 3. Due to this, the movable blade 34 is opened relative to the fixed blade 32.

As shown in FIG. 4, the trigger 28 is pivotably coupled to the nut 48 via the pin 64. The trigger 28 is also configured to move in the front-rear direction along with the movement of the nut 48 in the front-rear direction. Further, the trigger 28 is configured to pivot relative to the nut 48 about the pin 64 as a pivot axis in response to user's operation of pulling inward.

As shown in FIG. 3, the trigger position detector part 40 comprises a magnet 68, a spring 70, and a trigger position sensor 72 (see FIG. 4). The magnet 68 is positioned such that its front side (or rear side) has an N pole and its rear side (or front side) has an S pole. The magnet 68 is supported by the nut casing 50 movably in the front-rear direction. The spring 70 biases the magnet 68 frontward relative to the nut casing 50. A front end of the magnet 68 is in contact with a rear surface of the trigger 28. The trigger position sensor 72 shown in FIG. 4 comprises a Hall element, for example. The trigger position sensor 72 is fixed to the nut casing 50. The trigger position sensor 72 is configured to detect a pulling-inward position of the trigger 28 by detecting a position in the front-rear direction of the magnet 68 (see FIG. 3) relative to the nut casing 50.

The control unit 14 shown in FIG. 1 is configured to rotate the electric motor 36 forward or in reverse in accordance with a detection signal from the trigger position sensor 72. In response to the pulling-inward operation being performed on the trigger 28, the magnet 68 moves rearward than a neutral position relative to the nut casing 50, by which the control unit 14 causes the electric motor 36 to rotate forward. Due to this, the movable blade 34 pivots in a direction in which the movable blade 34 is closed relative to the fixed blade 32. Conversely, in response to the pulling-inward operation on the trigger 28 being released, the magnet 68 moves frontward than the neutral position relative to the nut casing 50, by which the control unit 14 causes the electric motor 36 to rotate in reverse. Due to this, the movable blade 34 pivots in a direction in which the movable blade 34 is opened relative to the fixed blade 32.

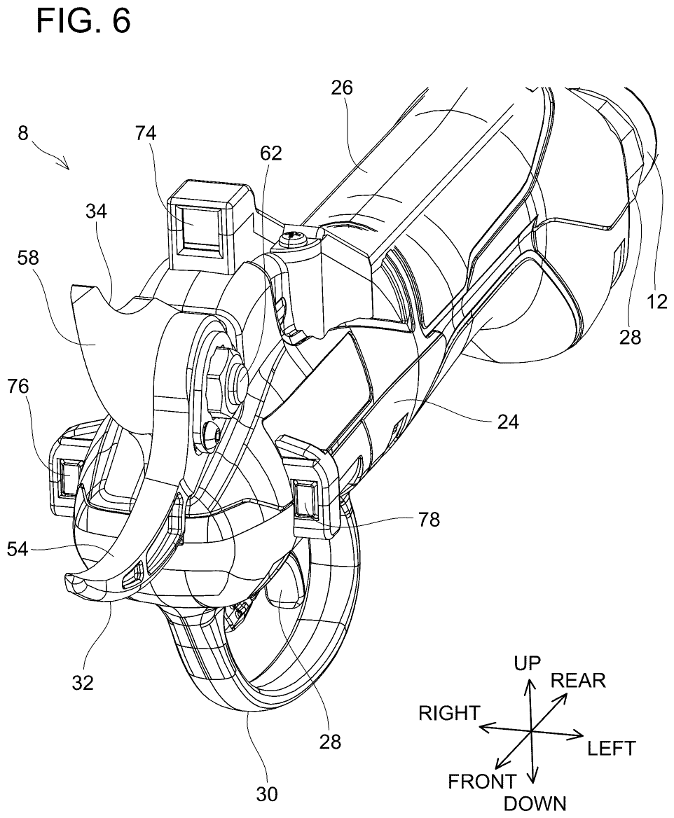

As shown in FIG. 6, the housing 24 comprises the camera 74, a right-side light 76, and a left-side light 78 disposed thereon. The camera 74 is disposed on an upper side of a front portion of the housing 24. The right-side light 76 is disposed on a right side of the front portion of the housing 24. The left-side light 78 is disposed on a left side of the front portion of the housing 24. Each of the right-side light 76 and the left-side light 78 is disposed to face frontward and illuminates a region near the fixed blade 32 and the movable blade 34.

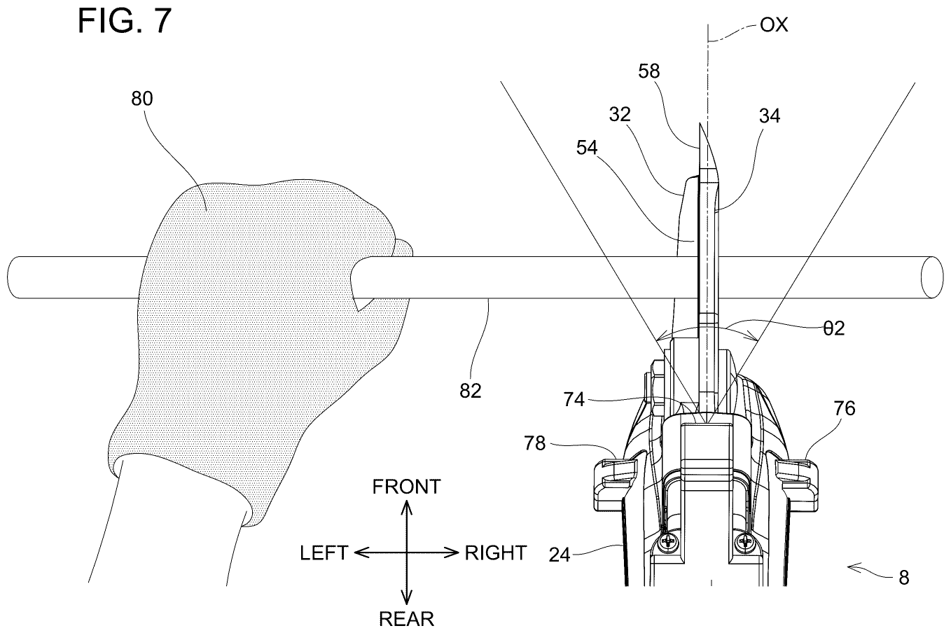

The camera 74 is disposed to face frontward, and captures an image of the region near the fixed blade 32 and the movable blade 34. Image data captured by the camera 74 is sent to the control unit 14 (see FIG. 1). As shown in FIG. 3, an optical axis OX of the camera 74 is set such that it is oriented diagonally downward with respect to an up-down direction, for example it is oriented downward by 12 degrees with respect to a horizontal direction. An angle of view 01 in the up-down direction of the camera 74 is for example within a range of 45 degrees to 90 degrees, and for example is 50 degrees. In this case, an entirety of the lower blade part 54 can be captured in the field of angle of the camera 74. As shown in FIG. 7, the optical axis OX of the camera 74 is disposed to be oriented frontward with respect to the left-right direction. An angle of view θ2 in the left-right direction of the camera 74 is for example within a range of 60 degrees to 120 degrees, and is for example 65 degrees. A focal length of the camera 74 is for example 50 mm to 100 mm. A resolution of the camera 74 is equal to or more than QVGA (320×240 pixels) for example, and is for example VGA (640×480 pixels). A frame rate of the camera 74 is for example equal to or more than 30 FPS. A shutter speed of the camera 74 is for example within a range of 0.1 ms to 2 ms, and is for example 1 ms.

As shown in FIG. 7, the user uses the working machine 2 with one hand gripping the grip 26 of the working unit 8 and a purple glove 80 worn on the other hand. For example, the user cuts a branch 82 by the working unit 8 gripped by the one hand, with the branch 82 gripped by the other hand wearing the glove 80, for example.

In cases where the working machine 2 is pruning shears, during normal work, green of leaves or blue of sky may be captured in the image data of the camera 74 but an object in purple is rarely captured in the same. Due to this, distinguishment from the colors that may be captured during normal work can be performed more easily by using the purple glove 80.

Distinguishment of colors that are captured in the camera 74 can be performed based on hues when each pixel included in image data are represented in HSV format which uses hue, saturation, and value (brightness). For example, a hue of brown of dead leaves or tree branches is within a range of 15 degrees to 60 degrees, a hue of green of leaves is within a range of 80degrees to 150 degrees, and a hue of blue of sky is within a range of 180 degrees to 225 degrees. Contrary to this, a hue of purple of the glove 80 is within a range of 270 degrees to 300 degrees. Due to this, based on the hue(s) of the pixel(s) captured in the image data, whether the pixel(s) correspond to the glove 80 or to something else can be distinguished.

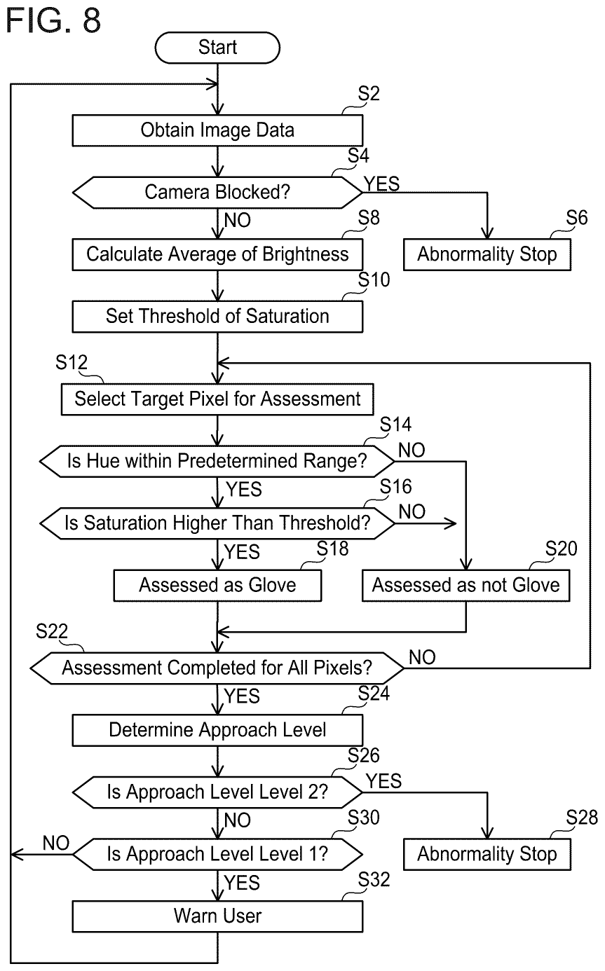

(Approach Assessment Process) The control unit 14 is configured to operate the working machine 2 in a safe mode in which the working machine 2 operates more safely than in a normal mode when it is determined based on image data of the camera 74 that the glove 80 is approaching the fixed blade 32 and the movable blade 34. Due to this, user safety can be ensured. Hereafter, with reference to FIG. 8, an approach assessment process performed by the control unit 14 will be described.

In S2, the control unit 14 obtains image data from the camera 74. The image data is represented in HSV format, and indicates a hue, a saturation, and a brightness for each pixel included in the image data.

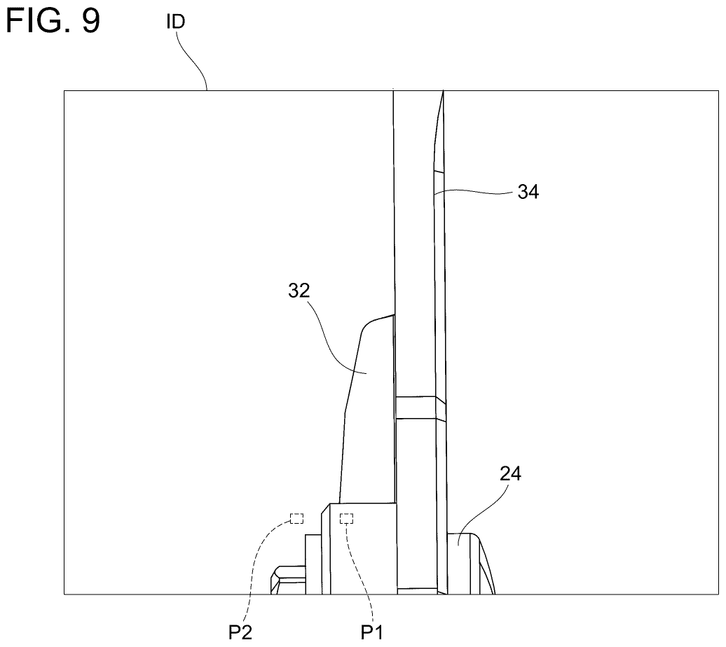

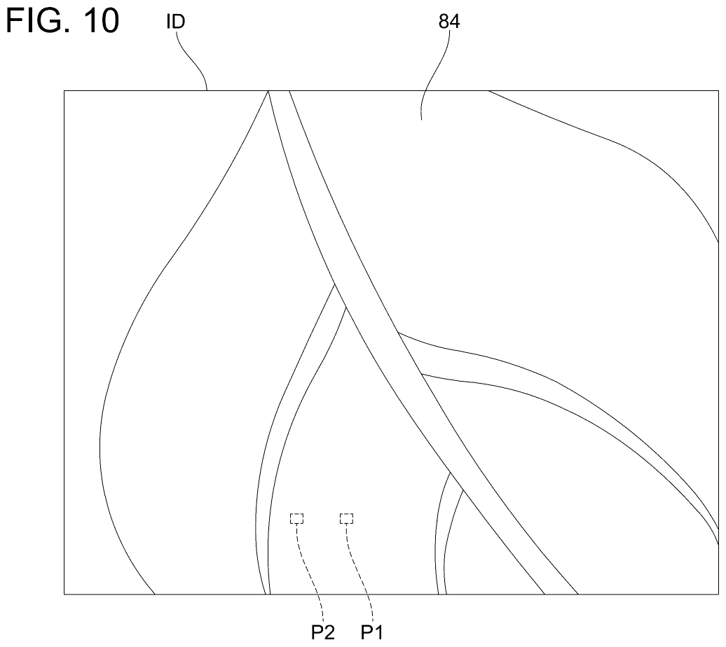

In S4, the control unit 14 determines whether the camera 74 is blocked based on the image data. As shown in FIG. 9, when the camera 74 is not blocked, the fixed blade 32, the movable blade 34, and background are captured in image data ID. In this state, since the fixed blade 32 does not move relative to the camera 74, the fixed blade 32 is inevitably captured in a pixel P1 located at a position corresponding to the fixed blade 32. On the other hand, leaves and/or branches in the background are captured in a pixel P2 located at a position not corresponding to the fixed blade 32 or the movable blade 34. Due to this, the pixels P1 and P2 exhibit different hues, saturations, and brightnesses. Contrary to this, when the camera 74 is blocked by an obstacle 84 as shown in FIG. 10, none of the fixed blade 32, the movable blade 34, or leaves/branches in the background are captured in the image data, but the same obstacle 84 is captured in almost all the pixels. In this case, the pixel P1 located at the position corresponding to the fixed blade 32 and the pixel P2 located at the position corresponding to neither the fixed blade 32 nor the movable blade 34 exhibit the same hues, saturations, and brightnesses. Accordingly, in S4 of FIG. 8, the control unit 14 compares respective pairs of the hues, saturations, and brightnesses between the pixel P1 and the pixel P2, and when all differences between each pair are 20% or less, the control unit 14 determines that the camera 74 is blocked by the obstacle 84.

When it is determined in S4 that the camera 74 is blocked (in case of YES), the process proceeds to S6. In S6, the control unit 14 puts an abnormality stop to the working machine 2. Specifically, the control unit 14 prohibits rotation of the electric motor 36, indicates occurrence of abnormality on the indicator lamp 20, and outputs a warning sound with the alarm 22 to notify the user that the camera 74 is blocked. After S6, the process of FIG. 8 ends.

When it is determined in S4 that the camera 74 is not blocked (in case of NO), the process proceeds to S8. In S8, the control unit 14 calculates an average of brightnesses of all the pixels in the image data.

In S10, the control unit 14 sets a threshold for saturation based on the average of brightnesses that was calculated in S8. For example, when the average of brightnesses is equal to a first reference value (e.g., 80%) or more, the control unit 14 sets the saturation threshold to a first threshold (e.g., 30%); when the average of brightnesses is equal to a second reference value (e.g., 50%) or more, in which the second reference value is smaller than the first reference value, the control unit 14 sets the saturation threshold to a second threshold (e.g., 50%), in which the second threshold is higher than the first threshold; and when the average of brightnesses is less than the second reference value, the control unit 14 sets the saturation threshold to a third threshold (e.g., 70%), in which the third threshold is higher than the second threshold.

In S12, the control unit 14 selects an assessment target pixel from among the pixel(s) captured in the image data for which an assessment process of S14 to S20 has not yet been conducted.

In S14, the control unit 14 determines whether the hue of the assessment target pixel falls into a predetermined range (e.g., 230 degrees to 360 degrees, e.g., 235 degrees to 320 degrees). When the hue of the assessment target pixel falls into the predetermined range (in case of YES), the process proceeds to S16.

In S16, the control unit 14 determines whether the saturation of the assessment target pixel is equal to the saturation threshold that was set in S10 or more. In cases where the image data is in HSV format, the hue of a color with low saturation such as white, gray, or black may be equal to that of a color with high saturation (e.g., purple). To address this in the present embodiment, when the saturation of the assessment target pixel is lower than the threshold, the assessment target pixel is determined as a pixel of white, gray, or black, and thus it is determined as not a pixel corresponding to the glove 80, and when the saturation of the assessment target pixel is equal to the threshold or more, the assessment target pixel is determined as the pixel of purple corresponding to the glove 80.

Here, in image data captured in luminous environments, the saturation of a pixel in which the purple glove 80 is captured tends to be lower, whereas in image data captured in dark environments, the saturation of a pixel in which the purple glove 80 is captured tends to be higher. Due to this, in the process of S10 in the present embodiment, the higher the average of brightnesses of the pixels included in the image data is, the lower the saturation threshold is set, whereas the lower the average of brightnesses of the pixels included in the image data is, the higher the saturation threshold is set. Due to this, erroneous detection caused by capturing a color with a low saturation can be effectively suppressed.

When in S16 the saturation of the assessment target pixel is at the saturation threshold or more (in case of YES), the process proceeds to S18. In S18, the control unit 14 assesses the assessment target pixel as the pixel corresponding to the glove 80. After S18, the process proceeds to S22.

When in S14 the hue of the assessment target pixel does not fall into the predetermined rage (in case of NO) and also in S16 the saturation of the assessment target pixel is lower than the threshold (in case of NO), the process proceeds to S20. In S20, the control unit 14 assesses the assessment target pixel as not the pixel corresponding to the glove 80. After S20, the process proceeds to S22.

In S22, the control unit 14 determines whether the assessment process of S14 to S20 has been finished for all the pixels included in the image data. When the assessment process has not yet been finished for all the pixels (in case of NO), the process returns to S12. When the assessment process has been finished for all the pixels (in case of YES), the process proceeds to S24.

In S24, the control unit 14 specifies an approach level of the glove 80 relative to the fixed blade 32 and the movable blade 34 based on the number of pixels that have been assessed as corresponding to the glove 80 among the pixels included in the image data. For example, when the number of all the pixel(s) included in the image data is NO and the number of pixel(s) corresponding to the glove 80 is N1, the control unit 14 specifies the approach level as level 0 in a case where a ratio N1/N0 is less than a first predetermined value (e.g., 3%); the control unit 14 specifies the approach level as level 1 in a case where the ratio N1/N0 is equal to the first predetermined value (e.g., 3%) or more and less than a second predetermined value (e.g., 5%); and the control unit 14 specifies the approach level as level 2 in a case where the ratio N1/N0 is equal to the second predetermined value (e.g., 5%) or more.

Alternatively, when the control unit 14 cuts a part including the fixed blade 32 and the movable blade 34 as a first partial image data from the image data and the number of all the pixel(s) included in the first partial image data is MO and the number of pixel(s) corresponding to the glove 80 in the first partial image data is M1, the control unit 14 may specify the approach level as level 1 in a case where a ratio M1/M0 is equal to a predetermined value (e.g., 4%) or more. Also, when the control unit 14 cuts a smaller part including the fixed blade 32 and the movable blade 34 as a second partial image data from the image data and the number of all the pixel(s) included in the second partial image data is L0 (L0<M0) and the number of pixel(s) corresponding to the glove 80 in the second partial image data is L1, the control unit 14 may specify the approach level as level 2 in a case where a ratio L1/L0 is equal to a predetermined value (e.g., 4%) or more. Furthermore, when the approach level does not apply to level 1 or level 2, the control unit 14 may specify the approach level as level 0.

In S26, the control unit 14 determines whether the approach level is level 2 or not.

When the approach level is level 2 (in case of YES), the process proceeds to S28. In S28, the control unit 14 prohibits the rotation of the electric motor 36, indicates occurrence of an abnormality on the indicator lamp 20, and outputs a warning sound with the alarm 22 to notify the user that the glove 80 is approaching too close to the fixed blade 32 and the movable blade 34. After S28, the process of FIG. 8 ends.

When in S26 the approach level is not level 2 (in case of NO), the process proceeds to S30. In S30, the control unit 14 determines whether the approach level is level 1 or not. When the approach level is level 1 (in case of YES), the process proceeds to S32. In S32, the control unit 14 indicates a warning on the indicator lamp 20, and outputs a warning sound with the alarm 22 to notify the user that the glove 80 is approaching the fixed blade 32 and the movable blade 34. Here, in S32, the rotation of the electric motor 36 is permitted, and thus the user can continue to conduct work using the working machine 2. After S32, the process returns to S2.

When in S30 the approach level is not level 1 (in case of NO), i.e., when the approach level is level 0, the process returns to S2.

When the approach level is level 0 by the processes of S24 to S32, the working machine 2 operates as it normally does. That is, the working machine 2 can be said as working in a normal mode when the approach level is level 0. Also, the working machine 2 operates more safely than in the normal mode when the approach level is level 1. That is, the working machine 2 can be said as operating in a first safe mode safer than the normal mode when the approach level is level 1. Further, the working machine 2 operates more safely than in the first safe mode when the approach level is level 2. That is, the working machine 2 can be said as operating in a second safe mode than the first safe mode when the approach level is level 2.

(Modifications) In the working machine 2 as described above, the battery unit 4 and the switch unit 6 may be mounted in the working unit 8. In this case, a battery receptacle (not shown) to/from which the battery pack 16 is attached/detached, the main power switch 18, and the indicator lamp 20 may be disposed on an outer surface of the housing 24 of the working unit 8. Also, the control unit 14 and the alarm 22 may be housed within the housing 24 of the working unit 8.

In the working machine 2 as described above, the predetermined range for hues may be any range as long as the range includes a hue of a color of a target object. Likewise, the color of the target object may not be limited to purple but may be another color.

The working machine 2 may be another type of working machine such as reciprocating saw, a rebar tying tool. For example, when the working machine 2 is a reciprocating saw, reciprocating saw blade(s) correspond to a working unit. When the working machine 2 is a rebar tying tool, a curl guide configured to feed wire about rebars and/or a hook configured to twist the wire wrapped about the rebars correspond to a working unit.

(Correspondences) As described above, in one or more embodiments, the working machine 2 comprises: the fixed blade 32 and the movable blade 34 (example for a working unit); the electric motor 36 (example for a prime mover) configured to drive the movable blade 34; the camera 74 (example for an image capture unit) configured to capture image data of an area near the fixed blade 32 and the movable blade 34; and the control unit 14. The working machine 2 is configured to operate in the normal mode in which the working machine 2 operates normally and in a safe mode in which the working machine 2 operates more safely than in the normal mode. The control unit 14 is configured to operate the working machine 2 in the safe mode when the control unit 14 determines that the glove 80 (example for an object) is approaching the fixed blade 32 and the movable blade 34 based on the number of pixels of which hue when the pixels are represented in an HSV format is within a predetermined range among pixels included in the image data captured by the camera 74.

When image data captured by the camera 74 is represented in the HSV format, objects of the same color exhibit the same hue even when they are captured in environments of different luminance. Due to this, according to the above configuration, it can be detected with high precision that the glove 80 is approaching the fixed blade 32 and the movable blade 34 based on the image data captured by the camera 74 even when the working machine 2 is used outdoors.

In one or more embodiments, the control unit 14 is configured to determine whether the glove 80 is approaching the fixed blade 32 and the movable blade 34 based on the number of pixels of which hue when the pixels are represented in the HSV format is within the predetermined range and of which saturation when the pixels are represented in the HSV format is equal to or higher than a threshold value among the pixels included in the image data captured by the camera 74.

When image data captured by the camera 74 is represented in the HSV format, a color with a low saturation such as white, black or gray may exhibit a same hue as a hue of a color with a high saturation (e.g., purple). Due to this, if an assessment on whether a pixel corresponds to the glove 80 or not is attempted based on the hue of that pixel alone, a pixel which captured a color with a low saturation may be erroneously assessed as the pixel corresponding to the glove 80. According to the above configuration, since a determination is made on whether the glove 80 is approaching the fixed blade 32 and the movable blade 34 or not based on the number of pixels of which hue is within the predetermined range and of which saturation is equal to or higher than a threshold value, such erroneous detection caused by a color with a low saturation having been captured can be suppressed.

In one or more embodiments, the control unit 14 is configured to set the saturation threshold value to a lower value as a brightness of a pixel when the pixel is represented in the HSV format included in the image data captured by the camera 74 is higher.

Generally, when image data is captured in a luminous environment, a saturation of a pixel corresponding to the purple glove 80 tends to be low, whereas when image data is captured in a dark environment, a saturation of a pixel corresponding to the purple glove 80 tends to be high. According to the above configuration, because the threshold value for the saturation is set to a lower value as a brightness of the pixel included in the image data is higher, approaching motion of the glove 80 toward the fixed blade 32 and the movable blade 34 can be detected with higher accuracy.

In one or more embodiments, the predetermined range for hues may be 230 degrees to 360 degrees.

When the working machine 2 is used outdoors, a blue color of sky, a green color of plants, and/or a brown color of tree branches or trunks may be captured in image data captured by the camera 74. Hues of theses colors are within a range of 0 degrees to 230 degrees, and a color of which hue is within a range of 230 degrees to 360 degrees (e.g., purple) is rarely captured in the image data. According to the above configuration, by setting the hue of the color of the glove 80 within the range of 230 degrees to 360 degrees, it is possible to detect with high precision that the glove 80 is approaching the fixed blade 32 and the movable blade 34.

In one or more embodiments, the working machine 2 further comprises the housing 24 supporting the fixed blade 32, the movable blade 34, and the camera 74 and configured to be gripped by a user. The movable blade 34 is configured to pivot around a pivot axis extending in the left-right direction with respect to the fixed blade 32 and configured to be driven by the electric motor 36.

The above-described working machine 2 works as pruning shears for pruning the branch 82 for example. A user may work with one hand grasping the housing 24 and another hand grasping the branch 82 when the user is to cut the branch 82 using the working machine 2. According to the above configuration, by wearing the glove 80 in a color of which hue falls into the predetermined range (e.g., purple) on the other hand, the working machine 2 can be made to operate in the safe mode when the glove 80 is approaching the fixed blade 32 and the movable blade 34. User safety can be ensured.

In one or more embodiments, the camera 74 is arranged on the upper side of the housing 24.

In a configuration where the working machine 2 comprises the fixed blade 32 and the movable blade 34, if the camera 74 is disposed on a right side (or left side) of the housing 24, an area to the right (or to the left) of the fixed blade 32 and the movable blade 34 enters a field of view of the camera 74 but an area to the left (or to the right) of the fixed blade 32 and the movable blade 34 is blocked by the fixed blade 32 and the movable blade 34 thus does not enter the field of view of the camera 74, as a result of which it becomes difficult to capture the areas to both left and right sides of the fixed blade 32 and the movable blade 34. Likewise, if the camera 74 is disposed on a bottom side of the housing 24, although the areas to both right and left of the fixed blade 32 and the movable blade 34 can be captured, the camera 74 would protrude downward from the housing 24, which often disturbs the work. According to the above configuration, since the camera 74 is disposed on the upper side of the housing 24, the areas to the right and left of the fixed blade 32 and the movable blade 34 can be captured. Also, the camera 74 can be suppressed from protruding downward from the housing 24 and thus disturbing the work.

In one or more embodiments, when the movable blade 34 is opened maximally with respect to the fixed blade 32 and a longitudinal direction of the housing 24 is set as a horizontal direction, the camera 74 is arranged below the upper end of the movable blade 34.

Even when the camera 74 protrudes upward from the housing 24 because the camera 74 is disposed on the upper side of the housing 24, as long as the camera 74 is located below the upper end of the movable blade 34 in a state where the movable blade 34 is opened maximally, the camera 74 hardly disturbs the work. According to the above configuration, even when the camera 74 protrudes upward from the housing 24, the camera 74 can be suppressed from disturbing the work.

In one or more embodiments, the working machine 2 further comprises the right-side light 76 and the left-side light 78 (example for an illumination unit) supported by the housing 24 and configured to illuminate the area near the fixed blade 32 and the movable blade 34.

According to the above configuration, even in a dark environment, because image data can be captured with the right-side light 76 and the left-side light 78 illuminating the area near the fixed blade 32 and the movable blade 34, the image data can be obtained under a same condition as when the image data is captured in a luminous environment. Variation in detection accuracy due to differences in luminance of environments can be suppressed.

In one or more embodiments, the right-side light 76 (example for a right illumination unit) is arranged on the right side of the housing 24, and the left-side light 78 (example for a left illumination unit) is arranged on the left side of the housing 24.

In the configuration where the working machine 2 comprises the fixed blade 32 and the movable blade 34, if the working machine 2 comprises only the right-side light 76 (or only the left-side light 78), the area to the right (or to the left) of the fixed blade 32 and the movable blade 34 is illuminated while the area to the left (or to the right) of the fixed blade 32 and the movable blade 34 is blocked by the fixed blade 32 and the movable blade 34 and thus not illuminated, thus it becomes difficult to illuminate the both areas to the right and left of the fixed blade 32 and the movable blade 34. According to the above configuration, because the working machine 2 comprises both the right-side light 76 and the left-side light 78, the areas to the right and left of the fixed blade 32 and the movable blade 34 can both be suitably illuminated.

In one or more embodiments, the control unit 14 is configured to specify the pixel P1 (example for a first pixel) and the pixel P2 (example for a second pixel) among the pixels included in the image data, the pixel P1 arranged at the position corresponding to the fixed blade 32 and the second pixel P2 arranged at the position corresponding to neither the fixed blade 32 nor the movable blade 34, and determine whether the camera 74 is blocked by the obstacle 84 based on hues, saturations, and/or brightnesses of the pixel P1 and the pixel P2 when the pixels P1 and P2 are represented in the HSV format.

When the camera 74 is not blocked by the obstacle 84, a same color (i.e., color of the fixed blade 32) is constantly captured in the pixel P1 arranged at the position corresponding to the fixed blade 32, and a color of background is captured in the pixel P2 arranged at the position that is not corresponding to the fixed blade 32 or the movable blade 34. In this case, the pixel P1 and the pixel P2 exhibit different hues, saturations, and brightnesses. Contrary to this, when the camera 74 is blocked by the obstacle 84, the same color of the obstacle 84 is captured by both the pixel P1 arranged at the position corresponding to the fixed blade 32 and the pixel P2 arranged at the position corresponding to neither the fixed blade 32 nor the movable blade 34. In this case, the pixels P1 and P2 exhibit substantially same hues, saturations, and brightnesses. According to the above configuration, whether the camera 74 is blocked by the obstacle 84 or not can be suitably distinguished based on hues, saturations, and/or brightnesses of the pixel P1 arranged at the position corresponding to the fixed blade 32 and the pixel P2 arranged at the position corresponding to neither the fixed blade 32 nor the movable blade 34.

In one or more embodiments, the angle of view in the left-right direction of the camera 74 is within a range of 60 degrees to 120 degrees.

If an angle of view is too wide in the left-right direction, even when the glove 80 is not so close to the fixed blade 32 and the movable blade 34 with respect to the left-right direction, the glove 80 would be captured in the image data. Conversely, if the angle of view is too narrow in the left-right direction, the glove 80 would not be captured in the image data until the glove 80 has significantly approached the fixed blade 32 and the movable blade 34. According to the above configuration, whether the glove 80 is approaching the fixed blade 32 and the movable blade 34 with respect to the left-right direction or not can be suitably detected.

In one or more embodiments, the angle of view in the up-down direction of the camera 74 is within a range of 45 degrees to 90 degrees.

If the angle of view is too wide in the up-down direction, even when the glove 80 is not so close to the fixed blade 32 and the movable blade 34 with respect to the up-down direction, the glove 80 would be captured in the image data. Conversely, if the angle of view is too narrow in the up-down direction, the glove 80 would not be captured in the image data until the glove 80 has significantly approached the fixed blade 32 and the movable blade 34. According to the above configuration, whether the glove 80 is approaching the fixed blade 32 and the movable blade 34 with respect to the up-down direction or not can be suitably detected.

In one or more embodiments, the shutter speed of the camera 74 is within a range of 0.1 ms to 2 ms.

According to the above configuration, the image data can be captured in a suitable luminance when the working machine 2 is used outdoors.

In one or more embodiments, the safe mode includes a first safe mode in which the working machine 2 operates more safely than in the normal mode and a second safe mode in which the working machine 2 operates more safely than in the first safe mode. The control unit 14 is configured to operate the working machine 2 in the first safe mode when it is determined that the glove 80 is approaching the fixed blade 32 and the movable blade 34 at an approach level of level 1 (example for a first approach level) based on the number of the pixels of which hue when the pixels are represented in the HSV format is within the predetermined range among the pixels included in the image data captured by the camera 74. The control unit 14 is configured to operate the working machine 2 in the second safe mode when it is determined that the glove 80 is approaching the fixed blade 32 and the movable blade 34 at an approach level of level 2 (example for a second approach level) that is closer than level 1 based on the number of the pixels of which hue when the pixels are represented in the HSV format is within the predetermined range among the pixels included in the image data captured by the camera 74.

According to the above configuration, the working machine 2 can be caused to operate in a safer mode in incremental steps according to the approach level of the glove 80 to the fixed blade 32 and the movable blade 34.

What is claimed is:

1. A working machine comprising:
a working unit;
a prime mover configured to drive the working unit;
an image capture unit configured to capture image data of an area near the working unit; and
a control unit,
wherein
the working machine is configured to operate in a normal mode in which the working machine operates normally and in a safe mode in which the working machine operates more safely than in the normal mode, and
the control unit is configured to operate the working machine in the safe mode when the control unit determines that an object is approaching the working unit based on a number of pixels of which hue when the pixels are represented in an HSV format is within a predetermined range among pixels included in the image data captured by the image capture unit.

2. The working machine according to claim 1, wherein the control unit is configured to determine whether the object is approaching the working unit based on the number of pixels of which hue when the pixels are represented in the HSV format is within the predetermined range and of which saturation when the pixels are represented in the HSV format is equal to or higher than a threshold value among the pixels included in the image data captured by the image capture unit.

3. The working machine according to claim 2, wherein the control unit is configured to set the threshold value to a lower value as a brightness of a pixel when the pixel is represented in the HSV format included in the image data captured by the image capture unit is higher.

4. The working machine according to claim 1, wherein the predetermined range is 230 degrees to 360 degrees.

5. The working machine according to claim 1, further comprising a housing supporting the working unit and the image capture unit and configured to be gripped by a user, wherein the working unit comprises a fixed blade and a movable blade, the movable blade being configured to pivot around a pivot axis extending in a left-right direction with respect to the fixed blade and configured to be driven by the prime mover.

6. The working machine according to claim 5, wherein the image capture unit is arranged on an upper side of the housing.

7. The working machine according to claim 6, wherein, when the movable blade is opened maximally with respect to the fixed blade and a longitudinal direction of the housing is set as a horizontal direction, the image capture unit is arranged below an upper end of the movable blade.

8. The working machine according to claim 5, further comprising an illumination unit supported by the housing and configured to illuminate the area near the working unit.

9. The working machine according to claim 8, wherein the illumination unit comprises a right illumination unit arranged on a right side of the housing and a left illumination unit arranged on a left side of the housing.

10. The working machine according to claim 5, wherein the control unit is configured to:
specify a first pixel and a second pixel among the pixels included in the image data, the first pixel arranged at a position corresponding to the fixed blade, and the second pixel arranged at a position corresponding to neither the fixed blade nor the movable blade; and
determine whether the image capture unit is blocked by an obstacle based on hues, saturations, and/or brightnesses of the first pixel and the second pixel when the first and second pixel are represented in the HSV format.

11. The working machine according to claim 5, wherein an angle of view in the left-right direction of the image capture unit is within a range of 60 degrees to 120 degrees.

12. The working machine according to claim 5, wherein an angle of view in an up-down direction of the image capture unit is within a range of 45 degrees to 90 degrees.

13. The working machine according to claim 5, wherein a shutter speed of the image capture unit is within a range of 0.1 ms to 2 ms.

14. The working machine according to claim 1, wherein the safe mode includes a first safe mode in which the working machine operates more safely than in the normal mode and a second safe mode in which the working machine operates more safely than in the first safe mode,
the control unit is configured to operate the working machine in the first safe mode when it is determined that the object is approaching the working unit at a first approach level based on the number of the pixels of which hue when the pixels are represented in the HSV format is within the predetermined range among the pixels included in the image data captured by the image capture unit, and
the control unit is configured to operate the working machine in the second safe mode when it is determined that the object is approaching the working unit at a second approach level that is closer than the first approach level based on the number of the pixels of which hue when the pixels are represented in the HSV format is within the predetermined range among the pixels included in the image data captured by the image capture unit.

15. The working machine according to claim 3, wherein the predetermined range is 230degrees to 360 degrees,
the working machine further comprises a housing supporting the working unit and the image capture unit and configured to be gripped by a user,
the working unit comprises a fixed blade and a movable blade, the movable blade being configured to pivot around a pivot axis extending in a left-right direction with respect to the fixed blade and configured to be driven by the prime mover,
the image capture unit is arranged on an upper side of the housing,
when the movable blade is opened maximally with respect to the fixed blade and a longitudinal direction of the housing is set as a horizontal direction, the image capture unit is arranged below an upper end of the movable blade,
the working machine further comprises an illumination unit supported by the housing and configured to illuminate the area near the working unit,
the illumination unit comprises a right illumination unit arranged on a right side of the housing and a left illumination unit arranged on a left side of the housing,
the control unit is configured to:
specify a first pixel and a second pixel among the pixels included in the image data, the first pixel arranged at a position corresponding to the fixed blade, and the second pixel arranged at a position corresponding to neither the fixed blade nor the movable blade; and
determine whether the image capture unit is blocked by an obstacle based on hues, saturations, and/or brightnesses of the first pixel and the second pixel when the first and second pixel are represented in the HSV format,
an angle of view in the left-right direction of the image capture unit is within a range of 60 degrees to 120 degrees,
an angle of view in an up-down direction of the image capture unit is within a range of 45 degrees to 90 degrees,
a shutter speed of the image capture unit is within a range of 0.1 ms to 2 ms,
the safe mode includes a first safe mode in which the working machine operates more safely than in the normal mode and a second safe mode in which the working machine operates more safely than in the first safe mode,
the control unit is configured to operate the working machine in the first safe mode when it is determined that the object is approaching the working unit at a first approach level based on the number of the pixels of which hue when the pixels are represented in the HSV format is within the predetermined range among the pixels included in the image data captured by the image capture unit, and
the control unit is configured to operate the working machine in the second safe mode when it is determined that the object is approaching the working unit at a second approach level that is closer than the first approach level based on the number of the pixels of which hue when the pixels are represented in the HSV format is within the predetermined range among the pixels included in the image data captured by the image capture unit.
